(19) United States
(12) Patent Application Publication
(10) Pub. No.: US 2026/0082426 A1
(43) Pub. Date: Mar. 19, 2026

(54) PHYSICAL RANDOM-ACCESS CHANNEL OCCASIONS FOR PHYSICAL RANDOM-ACCESS CHANNEL ADAPTATION

(71) Applicant: QUALCOMM Incorporated, San Diego, CA (US)

(72) Inventors: Hung Dinh LY, San Diego, CA (US); Ahmed Attia ABOTABL, San Diego, CA (US)

(21) Appl. No.: 18/887,582

(22) Filed: Sep. 17, 2024

(51) Int. Cl. H04W 74/0833; H04L 5/00

(52) U.S. Cl. CPC H04W 74/0833; H04L 5/0048

(57) ABSTRACT

Methods, systems, and devices for wireless communications are described. A user equipment (UE) may receive a signal that identifies a configuration for a set of physical random-access channel (PRACH) occasions that are within an association period, individual ones of a first subset of one or more PRACH occasions in the set of PRACH occasions are mapped to synchronization signal block (SSB) transmissions during the association period and individual ones of a second subset of one or more PRACH occasions in the set of PRACH occasions are unmapped to SSB transmissions during the association period. The UE may selectively perform one or more PRACH transmissions during the second subset of one or more PRACH occasions in the set of PRACH occasions according to an availability scheme, the availability scheme defines whether the second subset of one or more PRACH occasions is available or is unavailable for PRACH transmissions.

### FIELD OF TECHNOLOGY

The following relates to wireless communications, including physical random-access channel occasions for physical random-access channel adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a signal that identifies a configuration for a set of physical random-access channel (PRACH) occasions that are within an association period, where individual ones of a first subset of one or more PRACH occasions in the set of PRACH occasions are mapped to synchronization signal block (SSB) transmissions during the association period and individual ones of a second subset of one or more PRACH occasions in the set of PRACH occasions are unmapped to SSB transmissions during the association period and selectively performing one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions.

A UE for wireless communications is described. The UE may include one or more memories storing processor executable code, and one or more processors coupled with the one or more memories. The one or more processors may individually or collectively be operable to execute the code to cause the UE to receive a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period and selectively perform one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions.

Another UE for wireless communications is described. The UE may include means for receiving a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period and means for selectively performing one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions.

A non-transitory computer-readable medium storing code for wireless communications is described. The code may include instructions executable by one or more processors to receive a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period and selectively perform one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions.

In some examples of the method, user equipment (UEs), and non-transitory computer-readable medium described herein, the availability scheme defines the second subset of one or more PRACH occasions as additional PRACH occasions that may be available for PRACH transmissions.

In some examples of the method, user equipment (UEs), and non-transitory computer-readable medium described herein, the availability scheme defines the second subset of one or more PRACH occasions as unavailable for PRACH transmissions.

Some examples of the method, user equipment (UEs), and non-transitory computer-readable medium described herein may further include operations, features, means, or instructions for receiving a message that indicates the availability scheme to be applied to define the second subset of one or more PRACH occasions as available or as unavailable for PRACH transmissions.

Some examples of the method, user equipment (UEs), and non-transitory computer-readable medium described herein may further include operations, features, means, or instructions for detecting an absence of a message that indicates the availability scheme to be applied to define the second subset of one or more PRACH occasions as available or as unavailable for PRACH transmissions and selecting a default availability scheme as the availability scheme in accordance with the absence.

In some examples of the method, user equipment (UEs), and non-transitory computer-readable medium described herein, the availability scheme may be in accordance with whether the second subset of one or more PRACH occasions may be within an association period associated with the set of PRACH occasions and outside of a mapping cycle associated with the set of PRACH occasions.

A method for wireless communications by a UE is described. The method may include receiving a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period and selectively performing one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions.

A UE for wireless communications is described. The UE may include one or more memories storing processor executable code, and one or more processors coupled with the one or more memories. The one or more processors may individually or collectively be operable to execute the code to cause the UE to receive a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period and selectively perform one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions.

Another UE for wireless communications is described. The UE may include means for receiving a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period and means for selectively performing one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions.

A non-transitory computer-readable medium storing code for wireless communications is described. The code may include instructions executable by one or more processors to receive a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period and selectively perform one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions.

In some examples of the method, user equipment (UEs), and non-transitory computer-readable medium described herein, the mapping cycle association scheme redefines the additional set of PRACH occasions as being mapped to SSB transmissions within the mapping cycle.

In some examples of the method, user equipment (UEs), and non-transitory computer-readable medium described herein, the mapping cycle association scheme maintains the additional set of PRACH occasions as being unmapped to SSB transmissions.

A method for wireless communications by a UE is described. The method may include receiving a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold and selectively performing one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

A UE for wireless communications is described. The UE may include one or more memories storing processor executable code, and one or more processors coupled with the one or more memories. The one or more processors may individually or collectively be operable to execute the code to cause the UE to receive a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold and selectively perform one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

Another UE for wireless communications is described. The UE may include means for receiving a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold and means for selectively performing one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

A non-transitory computer-readable medium storing code for wireless communications is described. The code may include instructions executable by one or more processors to receive a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold and selectively perform one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

In some examples of the method, user equipment (UEs), and non-transitory computer-readable medium described herein, the repetition threshold scheme defines the PRACH occasions in the set of PRACH occasions as being included in the time period between PRACH occasions that may be mapped to SSB transmissions that satisfies the repetition threshold.

In some examples of the method, user equipment (UEs), and non-transitory computer-readable medium described herein, the repetition threshold scheme defines the PRACH occasions in both the set of PRACH occasions and the set of additional PRACH occasions as being included in the time period between PRACH occasions that may be mapped to SSB transmissions that satisfies the repetition threshold.

In some examples of the method, user equipment (UEs), and non-transitory computer-readable medium described herein, the repetition threshold scheme defines the PRACH occasions in the set of additional PRACH occasions as being included in the time period between PRACH occasions that may be mapped to SSB transmissions that satisfies the repetition threshold.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports physical random-access channel (PRACH) occasions for PRACH in accordance with one or more aspects of the present disclosure.

FIGS. 2A to 2C show examples of a PRACH configuration that supports PRACH occasions for PRACH adaptation in accordance with one or more aspects of the present disclosure.

FIGS. 3A and 3B show examples of a PRACH configuration that supports PRACH occasions for PRACH adaptation in accordance with one or more aspects of the present disclosure.

FIG. 4 shows an example of a PRACH configuration that supports PRACH occasions for PRACH adaptation in accordance with one or more aspects of the present disclosure.

FIG. 5 shows an example of a PRACH configuration that supports PRACH occasions for PRACH adaptation in accordance with one or more aspects of the present disclosure.

FIGS. 6 and 7 show block diagrams of devices that support PRACH occasions for PRACH adaptation in accordance with one or more aspects of the present disclosure.

FIG. 8 shows a block diagram of a communications manager that supports PRACH occasions for PRACH adaptation in accordance with one or more aspects of the present disclosure.

FIG. 9 shows a diagram of a system including a device that supports PRACH occasions for PRACH adaptation in accordance with one or more aspects of the present disclosure.

FIGS. 10 through 12 show flowcharts illustrating methods that support PRACH occasions for PRACH adaptation in accordance with one or more aspects of the present disclosure.

### DETAILED DESCRIPTION

Wireless networks may use physical random-access channel (PRACH) occasions for PRACH transmissions from a user equipment (UE) to the network. The PRACH transmissions may initiate a PRACH procedure between the UE and the network to establish a connection for wireless communications. The network may configure or otherwise define an association procedure that starts from frame zero to map synchronization signal block (SSB) indices to PRACH occasions (e.g., legacy PRACH occasions) such that a set of SSB indices are mapped to at least one PRACH occasion within the association period. The network may also configure additional PRACH occasions (e.g., for advanced UEs) within or outside of the association period. However, such networks may not define whether the PRACH occasion that is valid for legacy UEs but not mapped to an SSB transmission as an additional PRACH occasion for the advanced UEs. Other questions remain such as how the SSB indices to PRACH occasions within the mapping cycle are defined as well as which PRACH occasions are used to determine a repeated pattern within the association period.

Accordingly, aspects of the techniques described herein provide various mechanisms to more efficiently and effectively define and use PRACH occasions for UE. As one example, this may include a UE that receives or otherwise obtains a signal that identifies a configuration for a set of PRACH occasions that are within an association period. Individual ones of a first subset of one or more PRACH occasions in the set of PRACH occasions may be mapped to SSB transmissions during the association period. Individual ones of a second subset of one or more PRACH occasions in the set of PRACH occasions may be unmapped to SSB transmissions during the association period. The UE may selectively perform one or more PRACH transmissions during the second subset of one or more PRACH occasions in the set of PRACH occasions according to an availability scheme. The availability scheme may identify or otherwise define whether the second subset of one or more PRACH occasions is available or is unavailable for the PRACH transmissions.

Additionally, or alternatively, the techniques described herein may include the UE receiving or otherwise obtaining a signal that identifies a configuration for a set of PRACH occasions that are within an association period and an additional set of PRACH occasions that are also within the association period. Individual ones of a first subset of one or more PRACH occasions in the set of PRACH occasions may be mapped to SSB transmissions within a mapping cycle associated with the association period and individual ones of the additional set of PRACH occasions in the set of PRACH occasions are unmapped to SSB transmissions during the association period.

The UE may selectively perform one or more PRACH transmissions during the additional set of PRACH occasions in the set of PRACH occasions according to a mapping cycle association scheme. The mapping cycle association scheme may redefine the additional set of PRACH occasions as being mapped to SSB transmissions within the mapping cycle or maintain the additional set of PRACH occasions that are unmapped to SSB transmissions.

Additionally, or alternatively, the techniques described herein may include the UE receiving or otherwise obtaining a signal that identifies a configuration for an association period pattern, the association period pattern including one or more instances of an association period that includes a set of PRACH occasions that are within a mapping cycle of the association period and an additional set of PRACH occasions that are within the association period. The configuration identifies a time period between PRACH occasions that are mapped to SSB transmissions that satisfy a repetition threshold. The UE may selectively perform one or more PRACH transmissions during the set of additional PRACH occasions according to a repetition threshold scheme. The repetition threshold scheme may define whether PRACH occasions in the set of PRACH occasions, in the set of additional PRACH occasions, or both, are included in the time period between PRACH occasions that are mapped to SSB transmissions that satisfies the repetition threshold.

Aspects of the disclosure are initially described in the context of wireless communications systems. Aspects of the disclosure are further illustrated by and described with reference to apparatus diagrams, system diagrams, and flowcharts that relate to PRACH occasions for PRACH adaptation.

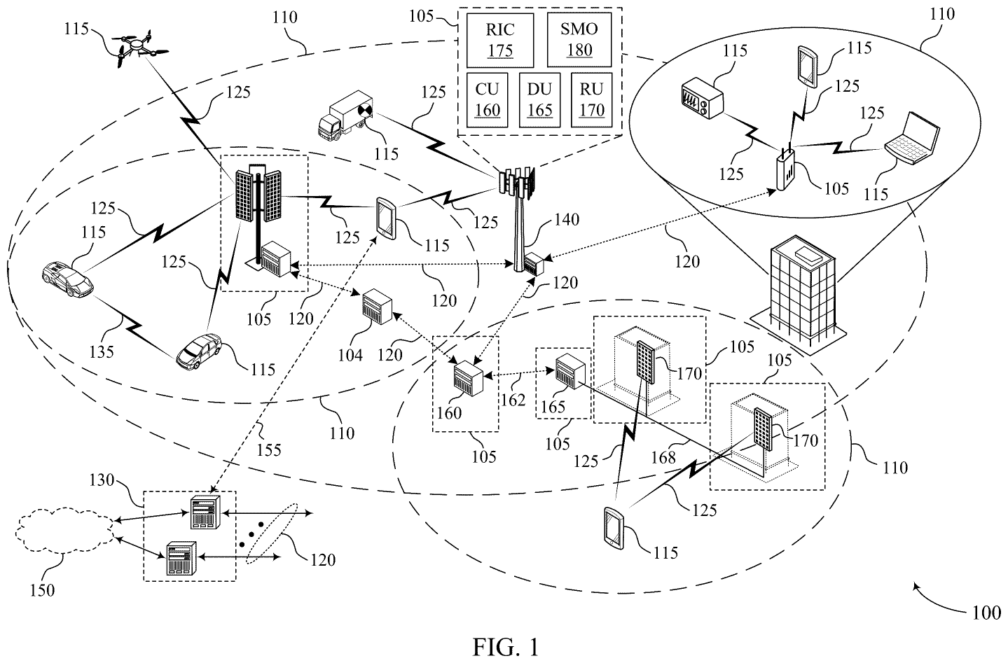

FIG. 1 shows an example of a wireless communications system 100 that supports PRACH occasions for PRACH adaptation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a signal that identifies a configuration for a set of PRACH occasions that are within an association period, wherein individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period. The UE 115 may selectively perform one or more PRACH transmissions during the second subset of one or more PRACH occasions in the set of PRACH occasions according to an availability scheme, wherein the availability scheme defines whether the second subset of one or more PRACH occasions is available or is unavailable for PRACH transmissions.

A UE 115 may receive a signal that identifies a configuration for a set of PRACH occasions that are within an association period and an additional set of PRACH occasions that are also within the association period, wherein individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period. The UE 115 may selectively perform one or more PRACH transmissions during the additional set of PRACH occasions according to a mapping cycle association scheme, wherein the mapping cycle association scheme redefines the additional set of PRACH occasions as being mapped to SSB transmissions within the mapping cycle or maintains the additional set of PRACH occasions as being unmapped to SSB transmissions.

A UE 115 may receive a signal that identifies a configuration for an association period pattern, the association period pattern comprising one or more instances of an association period that comprises a set of PRACH occasions that are within a mapping cycle of the association period and an additional set of PRACH occasions that are within the association period, wherein the configuration identifies a time period between PRACH occasions that are mapped to SSB transmissions that satisfies a repetition threshold. The UE 115 may selectively perform one or more PRACH transmissions during the set of additional PRACH occasions according to a repetition threshold scheme, wherein the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

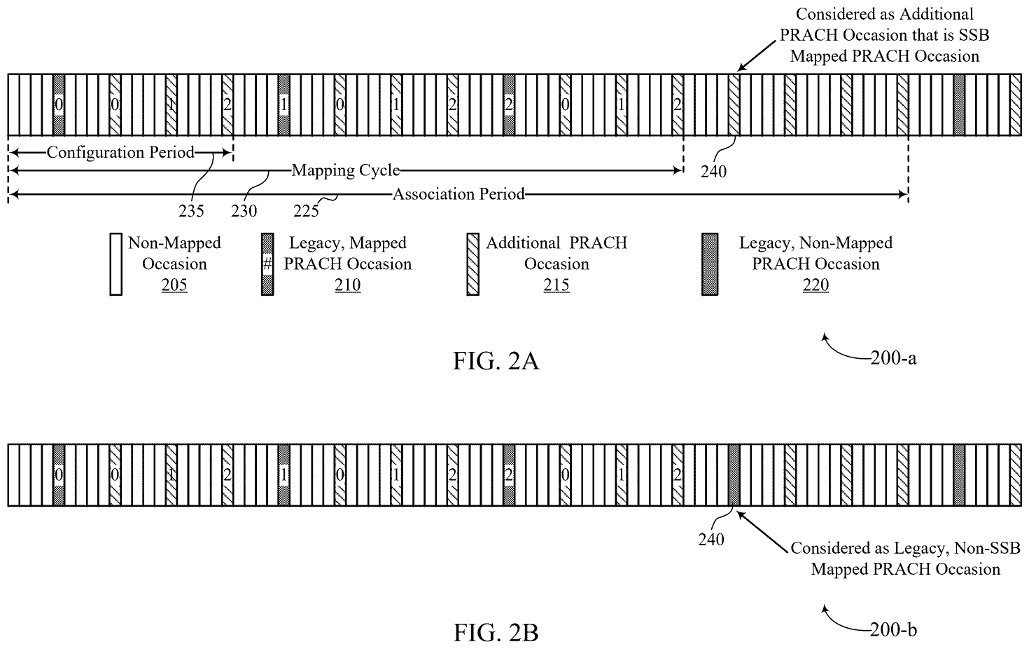

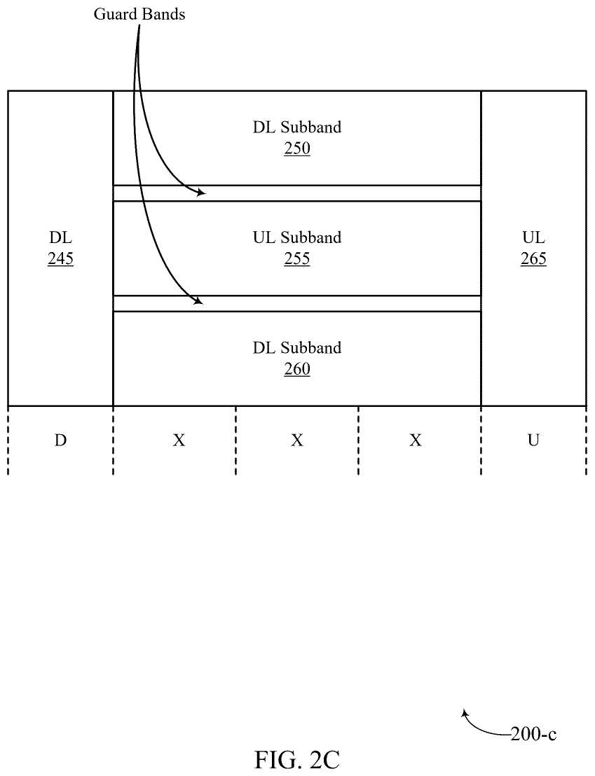

FIGS. 2A to 2C show examples of a PRACH configuration 200 that supports PRACH occasions for PRACH adaptation in accordance with one or more aspects of the present disclosure. Aspects of PRACH configuration 200 may be implemented at or implemented by aspects of wireless communications system 100. Aspects of PRACH configuration 200 may be implemented at or implemented by a UE or a network entity, which may be examples of the corresponding devices described herein.

Wireless networks may support various PRACH adaptations for improved performance. For example, the wireless networks may support the adaptation of the PRACH occasions in the time domain and, in some examples, in the spatial domain (such as non-uniform PRACH resources per-SSB). The wireless networks may support a unified PRACH adaption framework. The unified PRACH adaption framework in the time domain, in the spatial domain, or in both domains, may include a three-step process. The first step may include the configuration of PRACH resources (e.g., PRACH occasions) for some UE (e.g., such as legacy UE) and the semi-static configuration of additional PRACH resources for other UE ((e.g., such as for advanced or release 19 (R19)-capable UEs). The second step may include the activation or deactivation of the configured additional PRACH resources (e.g., using various signaling techniques, such as in a system information block one (SIB1), in a DCI format 2_7 used as a paging early indicator (PEI), in a paging DCI, or in a new DCI format). The third step generally includes the mapping between SSB transmissions and valid additional PRACH resources. For example, in the time domain adaption the additional PRACH resources may be provided for all transmitted SSBs. In the spatial domain adaptation the additional PRACH resources may be provided for a subset of the transmitted SSBs.

The adaptation of the PRACH resources (e.g., PRACH occasions) in the time-domain may support various features. For example, the adaptation may be based on the additional PRACH resources being used for network energy saving (NES)-capable UEs in addition to the PRACH resources configured for legacy UEs. In some aspects, the NES-capable UEs may use both the additional PRACH resources and the PRACH resources configured for legacy UEs. The configuration of the additional PRACH resources may be provided via semi-static signaling. In some cases, there may be an overlap of the additional PRACH resources and the PRACH resources configured for legacy UEs.

In the first step, different techniques may be used to semi-statically configure the additional PRACH resources. In some aspects, this may include, in addition to the first PRACH configuration index for the legacy UEs, a second PRACH configuration index being semi-statically configured to provide the PRACH configuration for advanced, NES-capable UEs. In some aspects, this may include the PRACH configuration periodicity in the PRACH configuration index for the legacy UEs being adapted to provide the additional PRACH resource configuration for the advanced, NES-capable UEs.

In the third step, the mapping between the SSB and the additional PRACH resources may be configured or otherwise indicated to the UE. For adaptation of the PRACH in the time-domain, an SSB-to-PRACH occasion (RO) mapping for the additional PRACH resources may be separate from the SSB-to-RO mapping for the PRACH resources for legacy UEs. In some aspects, this may be based on handling when SSB-RO mapping of the additional PRACH resources overlaps in both the time-domain and the frequency-domain with the PRACH resources for the legacy UEs. In some aspects, the SSB-to-RO mapping of the PRACH resources for the legacy UEs may not be impacted if the advanced UE uses these PRACH resources.

Different approaches may support a unified PRACH adaptation framework. For example, at least two approaches may be used that support PRACH adaptation in the spatial domain (e.g., non-uniform RO distribution for SSBs). One approach may include mapping SSB to valid configured aperiodic ROs and (de)activating the aperiodic ROs. Another approach may include (de)activation of value configured for the aperiodic ROs and mapping the SSBs to the activated ROs.

In some aspects, a “valid” PRACH occasion may be determined, such as based on the spectrum being used for wireless communications. In a paired spectrum or in a supplementary uplink band, all PRACH occasions may be considered valid. In an unpaired spectrum, the candidate synchronization signal (SS)/physical broadcast channel (PBCH) (e.g., SSB) index of the SS/PBCH block corresponds to the SS/PBCH block index provided by the RRC parameter ssb-PositionInBurst in SIB1 or in the parameter ServingCellConfigCommon configured for the UE. The SS/PBCH block indices provided in the ssb-PositionInBurst parameter in SIB1 or in the parameter ServingCellConfigCommon may be mapped to valid PRACH occasions in the following order. First, in increasing order of preamble indices within a single PRACH occasion. Second, in increasing order of frequency resource indices for frequency multiplexed PRACH occasions. Third, in increasing order of time resource indices for time multiplexed PRACH occasions within a PRACH slot. And fourth in increasing order of indices for the PRACH slots.

For example, the UE may receive or otherwise be configured with a PRACH configuration. The PRACH configuration may include an association period 225, starting from frame zero, that is used for mapping SS/PBCH block indices (e.g., SSB transmissions) to PRACH occasions that is the smallest value in the set determined by the PRACH configuration period 235 according to a (pre)configured table such that N_{Tx}^{SSB} SS/PBCH block indices are mapped at least once to the PRACH occasions within the association period 225. The UE may obtain N_{Tx}^{SSB} from the value of the ssb-PositionInBurst parameter in SIB1 or in the ServingCellConfigCommon parameter. If after an integer number of SS/PBCH block indices to PRACH occasions in the mapping cycle 230 within the association period 225 there is a set of PRACH occasions or PRACH preambles that are not mapped to N_{Tx}^{SSB} SS/PBCH block indices, no SS/PBCH block indices are mapped to the set of PRACH occasions or PRACH preambles. An association pattern period generally includes one or more of the association period 225 and is determined so that a pattern between PRACH occasions and SS/PBCH block indices repeats at most every 160 milliseconds. PRACH occasions not associated with a SS/PBCH block index after an integer number of the association period 225, if any, are not used for PRACH transmissions (e.g., are not generally considered valid PRACH occasions).

However, such networks may not provide sufficient guidance to enable access to some PRACH occasions for all UEs (e.g., advanced UEs, such as R19 UEs). For example, such configurations may not provide a mechanism that enables these UEs to determine whether to consider PRACH occasions that are configured and valid for legacy UEs but not mapped to any SSB index (e.g., SS/PBCH index) for the legacy UEs (e.g., such as the PRACH occasion identified by reference number 240) as an additional PRACH occasion that is available for use. Also, such configurations may not enable such UEs to determine how the SSB indices to PRACH occasions mapping cycle (e.g., the mapping cycle 230) are defined for the advanced UEs. Lastly, such configurations may not enable determination of which type of PRACH occasions should be used to determine the repeated pattern (e.g., the association pattern period). As one non-limiting example, the PRACH occasion identified by reference number 240 is a PRACH occasion that is not mapped to an SSB index for legacy UEs (e.g., only three SSBs are transmitted, corresponding to SSB indices 0, 1, and 2). Accordingly, the PRACH occasion marked as reference number 240 is generally not used by legacy UEs to send PRACH transmissions to the network.

For example, the UE may receive or otherwise obtain a signal (or signals) that carries or otherwise conveys information that identifies a configuration for a set of PRACH occasions that are within the association period 225. In some aspects, individual ones of a first subset of PRACH occasion(s) in the set of PRACH occasions may be mapped to SSB transmissions during the association period 225. For example, the set of PRACH occasions may include three of the legacy, mapped occasion 210, PRACH occasions although there may be more or less than three such PRACH occasions within the association period 225. These legacy, mapped occasion 210 PRACH occasions may correspond to the three SSB transmissions that correspond to SSB indices (e.g., SS/PBCH block indices) 0, 1 and 2, which are mapped to the SSB transmissions within the mapping cycle 230. The association period 225 may also include a plurality of non-mapped occasions 205 that are not mapped to PRACH resources.

In some aspects, the configuration for the set of PRACH occasions may also include a set of additional PRACH occasions (e.g., in addition to the set of PRACH occasions corresponding to the legacy, mapped occasion 210). The set of additional PRACH occasions is generally identified as the set of one or more of the additional PRACH occasion 215. The set of one or more additional PRACH occasion are generally configured for advanced UE, such as R19 UEs. For example, the set of one or more additional PRACH occasions may be used by the advanced UE for PRACH transmissions to the network. In some aspects, the additional PRACH occasion 215 in the set of one or more additional PRACH occasions that are within the mapping cycle 230 may be mapped to corresponding SSB transmissions. In some aspects, one or more of the additional PRACH occasion 215 in the additional set of PRACH occasions are unmapped to SSB transmissions during the association period 225 (e.g., such as the PRACH occasion identified by reference number 240).

Accordingly, in some examples individual ones of a second subset of PRACH occasion(s) in the set of PRACH occasions are unmapped to SSB transmissions during the association period 225. In this non-limiting example, the PRACH occasion identified by reference number 240 may correspond to a PRACH occasion in the second subset of PRACH occasions (e.g., in the set of additional PRACH occasions) that are not mapped to an SSB transmission. Accordingly, the UE may selectively perform PRACH transmissions during the second subset of one or more PRACH occasions in the set of PRACH occasions according to an availability scheme. The availability scheme may generally identify or otherwise define whether the second subset of one or more PRACH occasions are available or are unavailable for PRACH transmissions. Thus, the availability scheme may generally define whether the advanced UEs can consider the PRACH occasion(s) (e.g., those in the second subset of PRACH occasions) that are configured and valid for legacy UEs but not mapped to any SSB index for the legacy UEs as an additional PRACH occasion that is available for use by the advanced UEs.

Turning first to PRACH configuration 200-a of FIG. 2A, in some cases the availability scheme may indicate or otherwise define the PRACH occasion(s) that are configured and valid for legacy UEs but not mapped to any SSB index for the legacy UEs as an additional PRACH occasion for advanced UEs. As shown, the PRACH occasion in the second subset of PRACH occasion(s) (e.g., in the set of additional PRACH occasions) identified by reference number 240 is considered (e.g., by the advanced UEs) as an additional PRACH occasion 215 that can be used by the UE for PRACH transmissions. Accordingly, in this example the availability scheme may define the second subset of PRACH occasion(s) as an additional PRACH occasion 215 that is available for the PRACH transmissions. Thus, the UE may selectively perform the PRACH transmissions in this example.

In this example, the availability scheme may make the availability of the additional PRACH occasions for the advanced UE occur earlier in the time domain. Moreover, this approach may improve the mapping between the SSB indices to the additional PRACH occasions within an association period 225 to be completed earlier so that the network may stop PRACH monitoring in the association period 225.

Turning next to PRACH configuration 200-b of FIG. 2B, in this example the availability scheme generally defines the second subset of PRACH occasion(s) as unavailable for PRACH transmissions for the advanced UE. That is, in this example the advanced UE may not consider the PRACH occasion(s) that are configured and valid for legacy UEs but not mapped to any SSB index as an additional PRACH occasion. Thus and as is shown in FIG. 2B, the PRACH occasion identified by reference number 240 is considered as a legacy, non-mapped PRACH occasion 220 that cannot be used for PRACH transmissions by the advanced UE. Thus, the UE may selectively not perform the PRACH transmissions in this example.

In some aspects, the determination of whether to adopt the PRACH configuration 200-a of FIG. 2A (e.g., where the unmapped PRACH occasion(s) are available) or the PRACH configuration 200-b of FIG. 2B (e.g., where the unmapped PRACH occasion(s) are unavailable) may be configured or otherwise indicated to the UE. That is, whether to follow the available approach or the unavailable approach may be configured for the UE. For example, the UE may receive or otherwise obtain a message that carries or otherwise indicates the availability scheme to be applied to define the second subset of PRACH occasion(s) as available or unavailable for the PRACH transmissions. The message may be RRC-(pre)configured for the UE or using other signaling mechanisms, such as in a medium access control-control element (MAC-CE) or via DCI signaling.

If the UE is not provided with the configuration of the availability scheme, one of the approaches discussed above (e.g., either the available approach or the unavailable approach) may be a default approach for UE behavior. For example, the UE may identify or otherwise detect an absence of the message that indicates the availability scheme to be applied to define the second subset of PRACH occasion(s) as available or unavailable for the PRACH transmissions. Accordingly, in this example the UE may select or otherwise choose a default availability scheme as the availability scheme to be applied based on the absence. The default availability scheme may be the availability scheme where the PRACH occasions are considered as available (e.g., as shown in FIG. 2A) or the availability scheme where the PRACH occasions are unavailable (e.g., as shown in FIG. 2B).

In some aspects, the UE selectively performing the PRACH transmission may also be based on a mapping cycle association scheme. As discussed above, the UE may be configured with the set of PRACH occasions (e.g., the legacy, mapped occasion 210) and the set of additional PRACH occasions (e.g., the additional PRACH occasion 215). Individual ones of the PRACH occasions in the set of PRACH occasions are mapped to SSB transmissions within the mapping cycle 230 associated with the association period 225. However, individual ones of the PRACH occasions in the set of additional PRACH occasions may be unmapped to SSB transmissions during the association period 225 (e.g., such as the PRACH occasion identified by reference number 240). The mapping cycle association scheme may generally either redefine the set of set of additional PRACH occasions as being mapped to SSB transmissions within the mapping cycle 230 or maintains the set of additional PRACH occasions as being unmapped to SSB transmissions.

That is, aspects of the techniques described herein generally define how the SSB indices to PRACH occasion mapping cycle (e.g., the mapping cycle 230) is defined (e.g., for advanced UEs). If after an integer number of SS/PBCH block indices to additional PRACH occasions mapping cycles within the association period 225 there is a set of PRACH occasions or PRACH preambles that are not mapped to transmitted SS/PBCH block indexes, two alternatives may be applied according to the mapping cycle association scheme. One alternative may include no SS/PBCH block indices are mapped to the set of PRACH occasions or PRACH preambles. A second alternative may include the SS/PBCH block indices are mapped to the set of PRACH occasions or PRACH preambles.

In the non-limiting examples shown in PRACH configuration 200-a of FIG. 2A and the in the PRACH configuration 200-b of FIG. 2B, the first alternative is shown where no SS/PBCH block indices are mapped to SSB transmissions. That is, in the non-limiting example shown in FIG. 2 the mapping cycle association scheme may maintain the set of additional set of PRACH occasions as being unmapped to SSB transmissions.

As also discussed above, aspects of the techniques described herein generally identify or otherwise determine which PRACH occasions are used to determine the repeated pattern (e.g., a repetition threshold scheme). As discussed, an association pattern period may include one or more association periods (e.g., association period 225) and is determined so that a pattern between PRACH occasions and SS/PBCH block indexes repeats at most every 160 milliseconds. PRACH occasions that are not associated with SS/PBCH block indexes after an integer number of association periods, if any, are not used for PRACH transmissions.

Since an association period 225 may contain both PRACH occasions configured for legacy UEs and additional PRACH occasions for R19 UEs, a pattern between PRACH occasions and SS/PBCH block indexes that repeats at most every 160 milliseconds is unclear based on whether the “PRACH occasions” in determining the repeated pattern includes the PRACH occasions that are configured for legacy UEs only, or the additional PRACH occasions for R19 UEs only, or both PRACH occasions that are configured for legacy UEs and the additional PRACH occasions that are configured for R19 UEs.

Accordingly, the UE may receive or otherwise obtain a signal (or signals) that carry or otherwise convey a configuration for an association period pattern. The association period pattern may include one or more instances of an association period (e.g., the association period 225) that include a set of PRACH occasions that are within a mapping cycle (e.g., the mapping cycle 230) of the association period 225 and an additional set of PRACH occasions that are within the association period 225. In some aspects, the configuration may further identify or otherwise define a timer period between PRACH occasions that are mapped to SSB transmissions that satisfies a repetition threshold (e.g. 160 milliseconds).

Accordingly, the UE may selectively perform PRACH transmissions during the set of additional PRACH occasions according to a repetition threshold scheme. The repetition threshold scheme may generally identify, determine, or otherwise define whether PRACH occasions in the set of PRACH occasions, in the set of additional PRACH occasions, or in both sets, are included in the time period between PRACH occasions that are mapped to SSB transmissions that satisfy the repetition threshold.

In some cases, the repetition threshold scheme may define the PRACH occasions in the set of PRACH occasions as being included in the time period between PRACH occasions that are mapped to SSB transmissions that satisfy the repetition threshold. In this case, the PRACH occasions that are configured for legacy UEs (e.g., in the set of PRACH occasions) are used within the time period.

In some cases, the repetition threshold scheme may define the PRACH occasions in both the set of PRACH occasions and the set of additional PRACH occasions as being included in the time period between PRACH occasions that are mapped to SSB transmissions that satisfy the repetition threshold. Thus, in this case both the PRACH configurations configured for legacy UEs and the additional PRACH occasions configured for R19 UEs are used within the time period.

In some cases, the repetition threshold scheme may define the PRACH occasions in the set of additional PRACH occasions as being included in the time period between PRACH occasions that are mapped to SSB transmissions that satisfy the threshold. In this case, the additional PRACH occasions configured for R19 UEs are used within the time period.

Turning finally to PRACH configuration 200-c of FIG. 2C, in this example the availability scheme is applied when the UE is operating in a subband full-duplex (SBFD) mode. The SBFD mode may include the UE being configured for downlink communications (e.g., during a downlink (D) symbol or slot) in a downlink BWP 245 and for uplink communications (e.g., during an uplink (U) symbol or slot) in an uplink BWP 265. However, in this example the UE may be configured for duplex operations (even though the UE may be assumed to be a half-duplex UE and can only transmit uplink or receive downlink, but not both at the same time) that include downlink communications in a downlink subband 250 or in a downlink subband 260 during three (X) symbols or slots and for uplink communications in an uplink subband 255 during the three (X) symbols or slots. The downlink subband 250 may be separated in the frequency domain from the uplink subband 255 via a guard band. Similarly, the downlink subband 260 may be separated in the frequency domain from the uplink subband 255 via a guard band.

In this example, for random-access operations for SBFD-aware UEs operating in an RRC connected state or in an RRC idle/inactive state, the UE may use one single PRACH configuration with enhancements. In some aspects, the enhancements may include the PRACH occasions within the uplink subband 255 during the three (X) symbols or slots being valid occasions for SBFD-aware UE. In some aspects, the enhancements may include the use of two separate PRACH configurations, including one legacy PRACH configuration and one additional PRACH configuration. The PRACH occasions within the uplink subband 255 during the three (X) symbols or slots may be configured by the additional PRACH configuration to be valid PRACH occasions for SBFD-aware UE. That is, in this example the uplink resources provided in the uplink subband 255 may be used as additional PRACH resources or occasions in accordance with the techniques described herein.

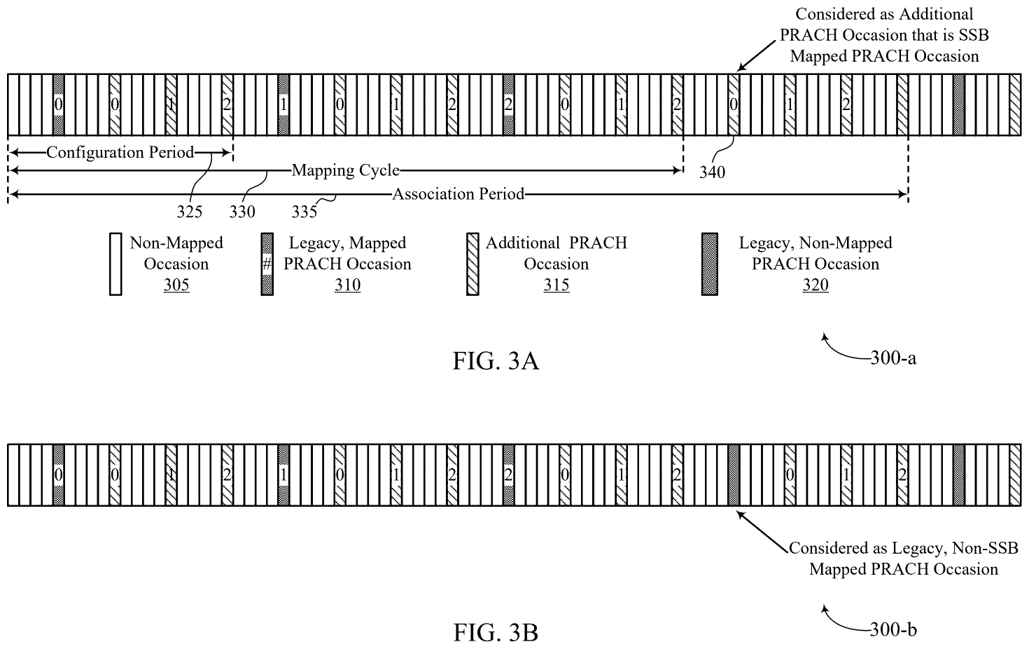

FIGS. 3A and 3B show examples of a PRACH configuration 300 that supports PRACH occasions for PRACH adaptation in accordance with one or more aspects of the present disclosure. Aspects of PRACH configuration 300 may implement or be implemented by aspects of wireless communications system 100 or aspects of PRACH configuration 200. Aspects of PRACH configuration 300 may be implemented at or implemented by a UE or a network entity, which may be examples of the corresponding devices described herein.

As discussed above, the UE may receive or otherwise obtain a signal (or signals) that carry or otherwise convey information that identifies a configuration for a set of PRACH occasions that are within the association period 335. In some aspects, individual ones of a first subset of PRACH occasion(s) in the set of PRACH occasions may be mapped to SSB transmissions during the association period 335. For example, the set of PRACH occasions may include three of the legacy, mapped occasion 310, although there may be more or less than three such PRACH occasions within the association period 335. These legacy, mapped occasion 310 may correspond to the three SSB transmissions that correspond to SSB indices (e.g., SS/PBCH block indices) zero, one and two, which are mapped to the SSB transmissions within the mapping cycle 330. The mapping cycle 330 may include one or more instances of a configuration period 325 for a given legacy, mapped occasion 310. The association period 335 may also include a plurality of non-mapped occasions 305 that are not mapped to PRACH resources.

In some aspects, the configuration for the set of PRACH occasions may also include a set of additional PRACH occasions (e.g., in addition to the set of PRACH occasions corresponding to the legacy, mapped occasion 310). The set of additional PRACH occasions is generally identified as the set of one or more of the additional PRACH occasion 315. The set of one or more additional PRACH occasion are generally configured for advanced UE, such as R19 UEs. For example, the set of one or more additional PRACH occasions may be used by the advanced UE for PRACH transmissions to the network. In some aspects, the additional PRACH occasion 315 in the set of one or more additional PRACH occasions that are within the mapping cycle 330 may be mapped to corresponding SSB transmissions. In some aspects, one or more of the additional PRACH occasion 315 in the additional set of PRACH occasions that are not within the mapping cycle 330 may be unmapped to SSB transmissions during the association period 335 (e.g., such as the PRACH occasion identified by reference number 340).

Accordingly, in some examples individual ones of a second subset of PRACH occasion(s) in the set of PRACH occasions are unmapped to SSB transmissions during the association period 335. In this non-limiting example, the PRACH occasion identified by reference number 340 may correspond to a PRACH occasion in the second subset of PRACH occasions (e.g., in the set of additional PRACH occasions) that are not mapped to an SSB transmission. Accordingly, the UE (e.g., advanced UE) may selectively perform PRACH transmissions during the second subset of one or more PRACH occasions in the set of PRACH occasions according to an availability scheme. That is, the availability scheme may generally identify or otherwise define whether the second subset of one or more PRACH occasions are available or are unavailable for PRACH transmissions. Thus, the availability scheme may generally define whether the advanced UEs can consider the PRACH occasion(s) (e.g., those in the second subset of PRACH occasions) that are configured and valid for legacy UEs but not mapped to any SSB index for the legacy UEs as an additional PRACH occasion that is available for use by the advanced UEs.

Turning first to PRACH configuration 300-a of FIG. 3A, in some cases the availability scheme may indicate or otherwise define the PRACH occasion(s) that are configured and valid for legacy UEs but not mapped to any SSB index for the legacy UEs as an additional PRACH occasion for advanced UEs. As shown, the PRACH occasion in the second subset of PRACH occasion(s) (e.g., in the set of additional PRACH occasions) identified by reference number 340 is considered (e.g., by the advanced UEs) as an additional PRACH occasion 315 that can be used by the UE for PRACH transmissions. Accordingly, in this example the availability scheme may define the second subset of PRACH occasion(s) as an additional PRACH occasion 315 that is available for the PRACH transmissions. Thus, the UE may selectively perform the PRACH transmissions in this example.

Turning next to PRACH configuration 300-b of FIG. 3B, in this example the availability scheme generally defines the second subset of PRACH occasion(s) as unavailable for PRACH transmissions for the advanced UE. That is, in this example the advanced UE may not consider the PRACH occasion(s) that are configured and valid for legacy UEs but not mapped to any SSB index as an additional PRACH occasion. Thus and as is shown in FIG. 3B, the PRACH occasion identified by reference number 340 is considered as a legacy, non-mapped PRACH occasion 320 that cannot be used for PRACH transmissions by the advanced UE. Thus, the UE may selectively not perform the PRACH transmissions in this example.

As also discussed above, the UE selectively performing the PRACH transmission may also be based on a mapping cycle association scheme. As discussed above, the UE may be configured with the set of PRACH occasions (e.g., the legacy, mapped occasion 310) and the set of additional PRACH occasions (e.g., the additional PRACH occasion 315). Individual ones of the PRACH occasions in the set of PRACH occasions are mapped to SSB transmissions within the mapping cycle 330 associated with the association period 335. However, individual ones of the PRACH occasions in the set of additional PRACH occasions may be unmapped to SSB transmissions during the association period 335 (e.g., such as the PRACH occasion identified by reference number 340 as well as the next three of the additional PRACH occasion 315). The mapping cycle association scheme may generally either redefine the set of set of additional PRACH occasions as being mapped to SSB transmissions within the mapping cycle 330 or maintains the set of additional PRACH occasions as being unmapped to SSB transmissions.

That is, aspects of the techniques described herein generally define how the SSB indices to PRACH occasion mapping cycle is defined (e.g., for advanced UEs). If after an integer number of SS/PBCH block indices to additional PRACH occasions mapping cycles within the association period 335 there is a set of PRACH occasions or PRACH preambles that are not mapped to transmitted SS/PBCH block indexes, two alternatives may be applied according to the mapping cycle association scheme. One alternative may include no SS/PBCH block indices are mapped to the set of PRACH occasions or PRACH preambles. A second alternative may include the SS/PBCH block indices are mapped to the set of PRACH occasions or PRACH preambles.

In the non-limiting examples shown in PRACH configuration 300-a of FIG. 3A, the second alternative is shown where SS/PBCH block indices are mapped to SSB transmissions. That is, in the non-limiting example shown in FIG. 3A the mapping cycle association scheme may redefine the set of additional set of PRACH occasions as being mapped to SSB transmissions. Thus, in this example the PRACH occasion identified by reference number 340 as well as the next two of the additional PRACH occasion 315 are mapped to SSB transmission (e.g., SS/PBCH block index) zero, one, and two, respectively. Thus, in this example the next two of the additional PRACH occasion 315 are mapped to SSB transmissions (e.g., SS/PBCH block indices) one and two, respectively.

In the non-limiting examples shown in PRACH configuration 300-b of FIG. 3B, the first alternative is shown where no SS/PBCH block indices are mapped to SSB transmissions for the PRACH occasion identified by reference number 340. That is, in the non-limiting example shown in FIG. 3B the mapping cycle association scheme may maintain the set of additional set of PRACH occasions as being unmapped to SSB transmissions. In some aspects, the PRACH occasion identified by reference number 340 may not be mapped to an SSB transmission due to being considered as unavailable in accordance with the availability scheme. However, in this example the next three of the additional PRACH occasion 315 are mapped to SSB indices zero, one, and two, respectively.

In some aspects, the first and second alternatives may be based on the adaptation scheme being applied. For example, in some examples the second alternative may be applied for PRACH adaption in the time domain while the first alternative may be applied in the spatial domain, or vice versa.

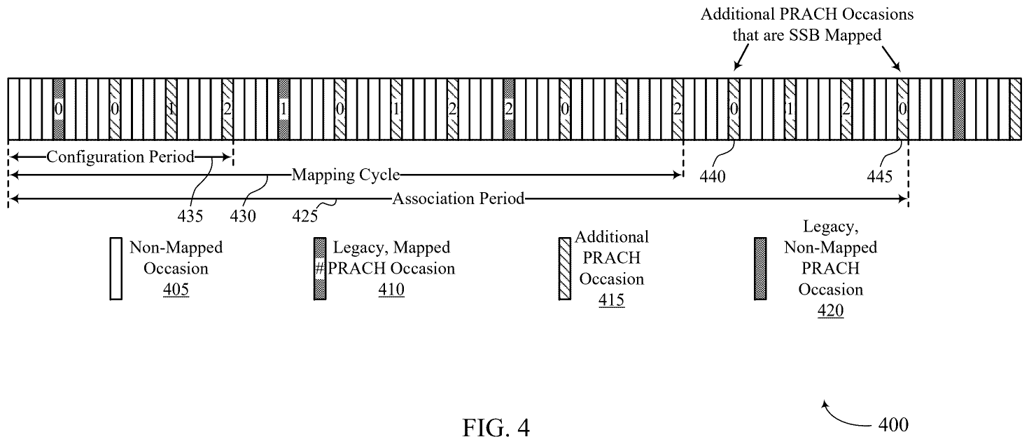

FIG. 4 shows an example of a PRACH configuration 400 that supports PRACH occasions for PRACH adaptation in accordance with one or more aspects of the present disclosure. Aspects of PRACH configuration 400 may implement or be implemented by aspects of wireless communications system 100 or aspects of PRACH configuration 200 or PRACH configuration 300. Aspects of PRACH configuration 400 may be implemented at or implemented by a UE or a network entity, which may be examples of the corresponding devices described herein.

As discussed above, the UE may receive or otherwise obtain a signal (or signals) that carry or otherwise conveys information that identifies a configuration for a set of PRACH occasions that are within the association period 425. In some aspects, individual ones of a first subset of PRACH occasion(s) in the set of PRACH occasions may be mapped to SSB transmissions during the association period 425. For example, the set of PRACH occasions may include three of the legacy, mapped occasion 410, although there may be more or less than three such PRACH occasions within the association period 425. These legacy, mapped occasion 410 may correspond to the three SSB transmissions that correspond to SSB indices (e.g., SS/PBCH block indices) zero, one and two which are mapped to the SSB transmissions within the mapping cycle 430. The mapping cycle 430 may include one or more PRACH configuration period 435 corresponding to the legacy, mapped occasion 410. The association period 425 may also include a plurality of non-mapped occasions 405 that are not mapped to PRACH resources.

In some aspects, the configuration for the set of PRACH occasions may also include a set of additional PRACH occasions (e.g., in addition to the set of PRACH occasions corresponding to the legacy, mapped occasion 410). The set of additional PRACH occasions is generally identified as the set of one or more of the additional PRACH occasion 415. The set of one or more additional PRACH occasion are generally configured for advanced UE, such as R19 UEs. For example, the set of one or more additional PRACH occasions may be used by the advanced UE for PRACH transmissions to the network. In some aspects, the additional PRACH occasion 415 in the set of one or more additional PRACH occasions that are within the mapping cycle 430 may be mapped to corresponding SSB transmissions. In some aspects, one or more of the additional PRACH occasion 415 in the additional set of PRACH occasions that are not within the mapping cycle 430 may be unmapped to SSB transmissions during the association period 425 (e.g., such as the PRACH occasion identified by reference number 440, which would otherwise be defined as a legacy, non-mapped PRACH occasion 420).

Accordingly, in some examples individual ones of a second subset of PRACH occasion(s) in the set of PRACH occasions are unmapped to SSB transmissions during the association period 425. In this non-limiting example, the PRACH occasion identified by reference number 440 may correspond to a PRACH occasion in the second subset of PRACH occasions (e.g., in the set of additional PRACH occasions) that is not mapped to an SSB transmission. Accordingly, the UE (e.g., advanced UE) may selectively perform PRACH transmissions during the second subset of one or more PRACH occasions in the set of PRACH occasions according to an availability scheme. That is, the availability scheme may generally identify or otherwise define whether the second subset of one or more PRACH occasions are available or are unavailable for PRACH transmissions. Thus, the availability scheme may generally define whether the advanced UEs can consider the PRACH occasion(s) (e.g., those in the second subset of PRACH occasions) that are configured and valid for legacy UEs but not mapped to any SSB index for the legacy UEs as an additional PRACH occasion that is available for use by the advanced UEs.

As shown in FIG. 4, in some cases the availability scheme may indicate or otherwise define the PRACH occasion(s) that are configured and valid for legacy UEs but not mapped to any SSB index for the legacy UEs as an additional PRACH occasion for advanced UEs. As shown, the PRACH occasion in the second subset of PRACH occasion(s) (e.g., in the set of additional PRACH occasions) identified by reference number 440 is considered (e.g., by the advanced UEs) as an additional PRACH occasion 415 that can be used by the UE for PRACH transmissions. Accordingly, in this example the availability scheme may define the second subset of PRACH occasion(s) as an additional PRACH occasion 415 that is available for the PRACH transmissions. The additional PRACH occasion 415 may, therefore, be mapped to an SSB index (e.g., SSB index zero in this example). Thus, the UE may selectively perform the PRACH transmissions in this example.

As also discussed above, the UE selectively performing the PRACH transmission may also be based on a mapping cycle association scheme. As discussed above, the UE may be configured with the set of PRACH occasions (e.g., the legacy, mapped occasion 410) and the set of additional PRACH occasions (e.g., the additional PRACH occasion 415). Individual ones of the PRACH occasions in the set of PRACH occasions are mapped to SSB transmissions within the mapping cycle 430 associated with the association period 425. However, individual ones of the PRACH occasions in the set of additional PRACH occasions may be unmapped to SSB transmissions during the association period 425 (e.g., such as the PRACH occasion identified by reference number 440 and the PRACH occasion identified by the reference number 445). The mapping cycle association scheme may generally either redefine the set of set of additional PRACH occasions as being mapped to SSB transmissions within the mapping cycle 430 or maintains the set of additional PRACH occasions as being unmapped to SSB transmissions.

That is, aspects of the techniques described herein generally define how the SSB indices to PRACH occasion mapping cycle is defined (e.g., for advanced UEs). If after an integer number of SS/PBCH block indices to additional PRACH occasions mapping cycles within the association period 425 there is a set of PRACH occasions or PRACH preambles that are not mapped to transmitted SS/PBCH block indexes, two alternatives may be applied according to the mapping cycle association scheme. One alternative may include no SS/PBCH block indices are mapped to the set of PRACH occasions or PRACH preambles. A second alternative may include the SS/PBCH block indices are mapped to the set of PRACH occasions or PRACH preambles.

In the non-limiting examples shown in PRACH configuration 400, the second alternative is shown where SS/PBCH block indices are mapped to SSB transmissions. That is, in the non-limiting example the mapping cycle association scheme may redefine the set of additional set of PRACH occasions as being mapped to SSB transmissions. Thus, in this example the PRACH occasions identified by reference number 440 and by the reference number 445 as being mapped to SSB transmission (e.g., SS/PBCH block index) zero, respectively. Also in this example, the next two of the additional PRACH occasion 415 are mapped to SSB transmissions (e.g., SS/PBCH block indices) one and two, respectively.

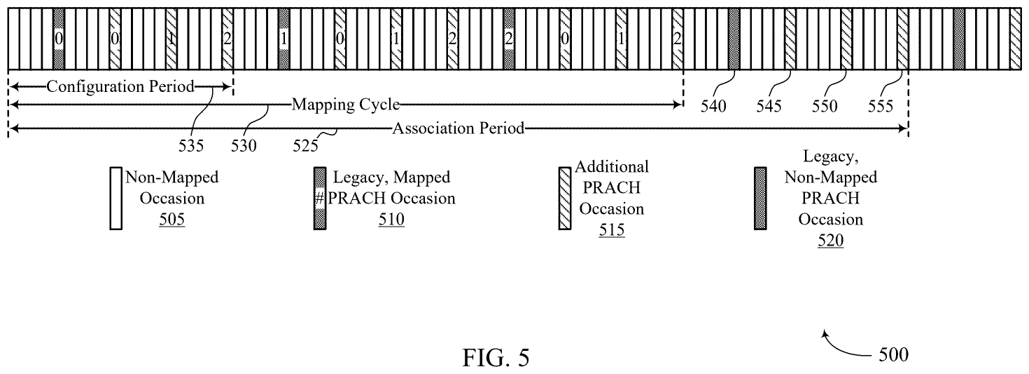

FIG. 5 shows an example of a PRACH configuration 500 that supports PRACH occasions for PRACH adaptation in accordance with one or more aspects of the present disclosure. Aspects of PRACH configuration 500 may implement or be implemented by aspects of wireless communications system 100 or aspects of PRACH configuration 200, PRACH configuration 300, or PRACH configuration 400. Aspects of PRACH configuration 500 may be implemented at or implemented by a UE or a network entity, which may be examples of the corresponding devices described herein.

As discussed above, the UE may receive or otherwise obtain a signal (or signals) that carry or otherwise conveys information that identifies a configuration for a set of PRACH occasions that are within the association period 525. In some aspects, individual ones of a first subset of PRACH occasion(s) in the set of PRACH occasions may be mapped to SSB transmissions during the association period 525. For example, the set of PRACH occasions may include three of the legacy, mapped occasion 510, although there may be more or less than three such PRACH occasions within the association period 525. These legacy, mapped occasion 510 may correspond to the three SSB transmissions that correspond to SSB indices (e.g., SS/PBCH block indices) zero, one and two, which are mapped to the SSB transmissions within the mapping cycle 530. The mapping cycle 530 may include one or more instances of the PRACH configuration period 535 that correspond to at least one legacy, mapped occasion 510. The association period 525 may also include a plurality of non-mapped occasions 505 that are not mapped to PRACH resources.

In some aspects, the configuration for the set of PRACH occasions may also include a set of additional PRACH occasions (e.g., in addition to the set of PRACH occasions corresponding to the legacy, mapped occasion 510). The set of additional PRACH occasions is generally identified as the set of one or more of the additional PRACH occasion 515. The set of one or more additional PRACH occasions are generally configured for advanced UE, such as R19 UEs. For example, the set of one or more additional PRACH occasions may be used by the advanced UE for PRACH transmissions to the network. In some aspects, the additional PRACH occasion 515 in the set of one or more additional PRACH occasions that are within the mapping cycle 530 may be mapped to corresponding SSB transmissions. In some aspects, one or more of the additional PRACH occasions 515 in the additional set of PRACH occasions that are not within the mapping cycle 530 may be unmapped to SSB transmissions during the association period 525 (e.g., such as the PRACH occasion identified by reference number 540).

Accordingly, in some examples individual ones of a second subset of PRACH occasion(s) in the set of PRACH occasions are unmapped to SSB transmissions during the association period 525. In this non-limiting example, the PRACH occasion identified by reference number 540 may correspond to a PRACH occasion in the second subset of PRACH occasions (e.g., in the set of additional PRACH occasions) that is not mapped to an SSB transmission. Accordingly, the UE (e.g., advanced UE) may selectively perform PRACH transmissions during the second subset of one or more PRACH occasions in the set of PRACH occasions according to an availability scheme. That is, the availability scheme may generally identify or otherwise define whether the second subset of one or more PRACH occasions are available or are unavailable for PRACH transmissions. Thus, the availability scheme may generally define whether the advanced UEs can consider the PRACH occasion(s) (e.g., those in the second subset of PRACH occasions) that are configured and valid for legacy UEs but not mapped to any SSB index for the legacy UEs as an additional PRACH occasion that is available for use by the advanced UEs.

As shown in FIG. 5, in some cases the availability scheme may indicate or otherwise define the PRACH occasion(s) that are configured and valid for legacy UEs but not mapped to any SSB index for the legacy UEs as unavailable for PRACH transmissions. As shown, the PRACH occasion in the second subset of PRACH occasion(s) (e.g., in the set of additional PRACH occasions) identified by reference number 540 is not considered (e.g., by the advanced UEs) as an additional PRACH occasion 515 that can be used by the UE for PRACH transmissions. Accordingly, in this example the availability scheme may define the second subset of PRACH occasion(s) as a legacy, non-mapped PRACH occasion 520 that is unavailable for the PRACH transmissions. The legacy, non-mapped PRACH occasion 520 may, therefore, be unmapped to an SSB index. Thus, the UE may selectively not perform the PRACH transmissions in this example.

As also discussed above, the UE selectively performing the PRACH transmission may also be based on a mapping cycle association scheme. As discussed above, the UE may be configured with the set of PRACH occasions (e.g., the legacy, mapped occasion 510) and the set of additional PRACH occasions (e.g., the additional PRACH occasion 515). Individual ones of the PRACH occasions in the set of PRACH occasions are mapped to SSB transmissions within the mapping cycle 530 associated with the association period 525. However, individual ones of the PRACH occasions in the set of additional PRACH occasions may be unmapped to SSB transmissions during the association period 525 (e.g., such as the PRACH occasions identified by reference number 540, by reference number 545, by reference number 550, and by reference number 555). The mapping cycle association scheme may generally either redefine the set of set of additional PRACH occasions as being mapped to SSB transmissions within the mapping cycle 530 or maintains the set of additional PRACH occasions as being unmapped to SSB transmissions. In this non-limiting example, the set of additional PRACH occasions (e.g., the PRACH occasions identified by reference number 540) are maintained as being unmapped to SSB indices.

That is, aspects of the techniques described herein generally define how the SSB indices to PRACH occasion mapping cycle is defined (e.g., for advanced UEs). If after an integer number of SS/PBCH block indices to additional PRACH occasions mapping cycles within the association period 525 there is a set of PRACH occasions or PRACH preambles that are not mapped to transmitted SS/PBCH block indexes, two alternatives may be applied according to the mapping cycle association scheme. One alternative may include no SS/PBCH block indices are mapped to the set of PRACH occasions or PRACH preambles. A second alternative may include the SS/PBCH block indices are mapped to the set of PRACH occasions or PRACH preambles.

In the non-limiting examples shown in PRACH configuration 500, the first alternative is shown where SS/PBCH block indices are unmapped to SSB transmissions for at least some of the PRACH occasion(s) in the set of additional PRACH occasions. That is, in the non-limiting example the mapping cycle association scheme may maintain the set of additional set of PRACH occasions (e.g., the PRACH occasion identified by reference number 540) as being unmapped to SSB transmissions. Thus, in this example the PRACH occasion identified by reference number 540 is unmapped to SSB transmission (e.g., SS/PBCH block index).

Also, aspects of the techniques described herein may generally provide for the availability scheme to be in accordance with whether the second subset of one or more PRACH occasions (e.g., the PRACH occasion identified by reference number 540) is within an association period associated with the set of PRACH occasions and outside of a mapping cycle associated with the set of PRACH occasions. That is, whether or not the PRACH occasion that is configured and valid for legacy UEs but not mapped to any SSB index for the legacy UEs is considered as an additional PRACH occasion may depend on whether the additional PRACH occasions within the associated period but outside of the SSB to PRACH occasion mapping cycle can be used for the advanced UE. If a subset of the additional PRACH occasions can be used by the advanced UEs, the PRACH occasions can be used as an additional PRACH occasion. Otherwise, it cannot be used. In this non-limiting example, this may include the PRACH occasions identified by reference number 545, reference number 550, and reference number 555 as being considered as an additional PRACH occasions based on whether the PRACH occasion identified by reference number 540 can be used as an additional PRACH occasion. Thus, the PRACH occasions identified by reference number 545, by reference number 550, and by reference number 555 are unmapped to SSB indices but are otherwise available for PRACH transmissions.

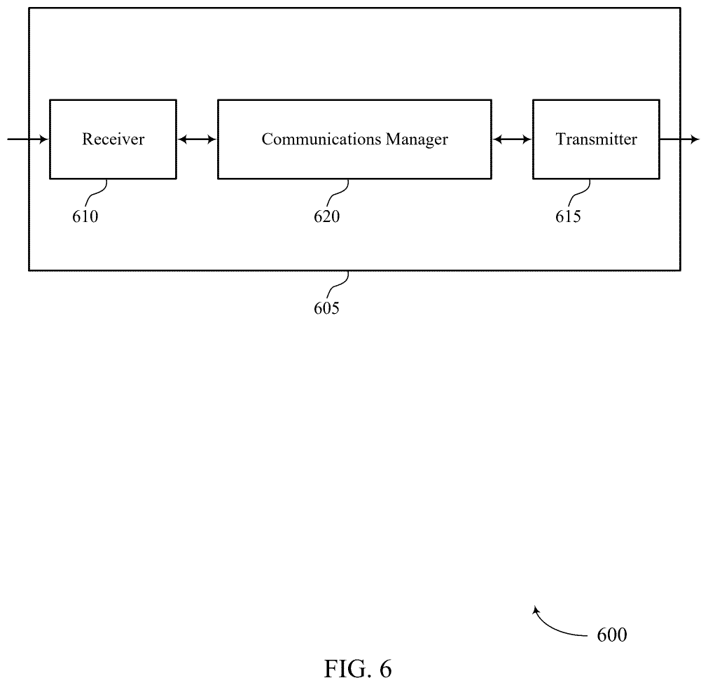

FIG. 6 shows a block diagram 600 of a device 605 that supports PRACH occasions for PRACH adaptation in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to PRACH occasions for PRACH adaptation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to PRACH occasions for PRACH adaptation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of PRACH occasions for PRACH adaptation as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period. The communications manager 620 is capable of, configured to, or operable to support a means for selectively performing one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions.

Additionally, or alternatively, the communications manager 620 may support wireless communications in accordance with examples as disclosed herein. For example, the communications manager 620 is capable of, configured to, or operable to support a means for receiving a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period. The communications manager 620 is capable of, configured to, or operable to support a means for selectively performing one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions.

Additionally, or alternatively, the communications manager 620 may support wireless communications in accordance with examples as disclosed herein. For example, the communications manager 620 is capable of, configured to, or operable to support a means for receiving a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold. The communications manager 620 is capable of, configured to, or operable to support a means for selectively performing one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for improved PRACH configuration(s) to UE. The PRACH configuration(s) may generally define or otherwise identify whether additional PRACH occasions are available for use, are mapped to SSB indices, or otherwise considered as within a time period for such UE.

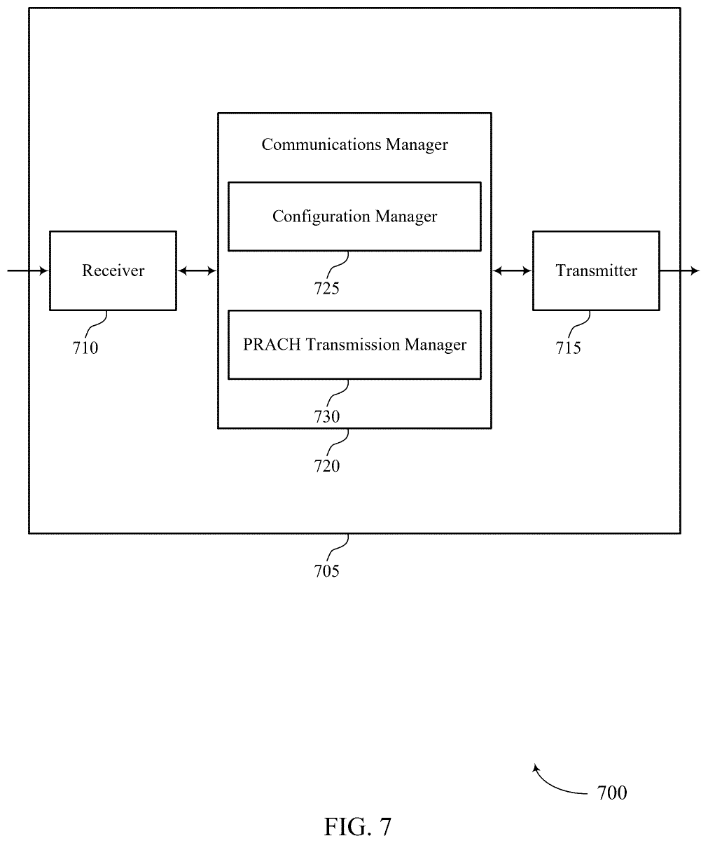

FIG. 7 shows a block diagram 700 of a device 705 that supports PRACH occasions for PRACH adaptation in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to PRACH occasions for PRACH adaptation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PRACH occasions for PRACH adaptation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of PRACH occasions for PRACH adaptation as described herein. For example, the communications manager 720 may include a configuration manager 725 a PRACH transmission manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration manager 725 is capable of, configured to, or operable to support a means for receiving a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period. The PRACH transmission manager 730 is capable of, configured to, or operable to support a means for selectively performing one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions.

Additionally, or alternatively, the communications manager 720 may support wireless communications in accordance with examples as disclosed herein. The configuration manager 725 is capable of, configured to, or operable to support a means for receiving a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period. The PRACH transmission manager 730 is capable of, configured to, or operable to support a means for selectively performing one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions.

Additionally, or alternatively, the communications manager 720 may support wireless communications in accordance with examples as disclosed herein. The configuration manager 725 is capable of, configured to, or operable to support a means for receiving a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold. The PRACH transmission manager 730 is capable of, configured to, or operable to support a means for selectively performing one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

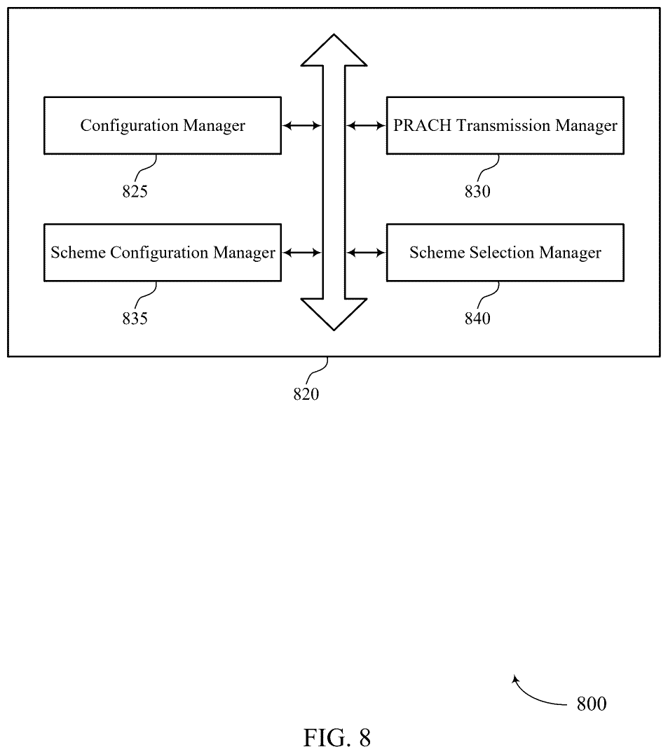

FIG. 8 shows a block diagram 800 of a communications manager 820 that supports PRACH occasions for PRACH adaptation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of PRACH occasions for PRACH adaptation as described herein. For example, the communications manager 820 may include a configuration manager 825, a PRACH transmission manager 830, a scheme configuration manager 835, a scheme selection manager 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration manager 825 is capable of, configured to, or operable to support a means for receiving a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period. The PRACH transmission manager 830 is capable of, configured to, or operable to support a means for selectively performing one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions. In some examples, the availability scheme defines the second subset of one or more PRACH occasions as additional PRACH occasions that are available for PRACH transmissions. In some examples, the availability scheme defines the second subset of one or more PRACH occasions as unavailable for PRACH transmissions.

In some examples, the scheme configuration manager 835 is capable of, configured to, or operable to support a means for receiving a message that indicates the availability scheme to be applied to define the second subset of one or more PRACH occasions as available or as unavailable for PRACH transmissions.

In some examples, the scheme selection manager 840 is capable of, configured to, or operable to support a means for detecting an absence of a message that indicates the availability scheme to be applied to define the second subset of one or more PRACH occasions as available or as unavailable for PRACH transmissions. In some examples, the scheme selection manager 840 is capable of, configured to, or operable to support a means for selecting a default availability scheme as the availability scheme in accordance with the absence. In some examples, the availability scheme is in accordance with whether the second subset of one or more PRACH occasions are within an association period associated with the set of PRACH occasions and outside of a mapping cycle associated with the set of PRACH occasions.

Additionally, or alternatively, the communications manager 820 may support wireless communications in accordance with examples as disclosed herein. In some examples, the configuration manager 825 is capable of, configured to, or operable to support a means for receiving a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period. In some examples, the PRACH transmission manager 830 is capable of, configured to, or operable to support a means for selectively performing one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions. In some examples, the mapping cycle association scheme redefines the additional set of PRACH occasions as being mapped to SSB transmissions within the mapping cycle. In some examples, the mapping cycle association scheme maintains the additional set of PRACH occasions as being unmapped to SSB transmissions.

Additionally, or alternatively, the communications manager 820 may support wireless communications in accordance with examples as disclosed herein. In some examples, the configuration manager 825 is capable of, configured to, or operable to support a means for receiving a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold. In some examples, the PRACH transmission manager 830 is capable of, configured to, or operable to support a means for selectively performing one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

In some examples, the repetition threshold scheme defines the PRACH occasions in the set of PRACH occasions as being included in the time period between PRACH occasions that are mapped to SSB transmissions that satisfies the repetition threshold. In some examples, the repetition threshold scheme defines the PRACH occasions in both the set of PRACH occasions and the set of additional PRACH occasions as being included in the time period between PRACH occasions that are mapped to SSB transmissions that satisfies the repetition threshold. In some examples, the repetition threshold scheme defines the PRACH occasions in the set of additional PRACH occasions as being included in the time period between PRACH occasions that are mapped to SSB transmissions that satisfies the repetition threshold.

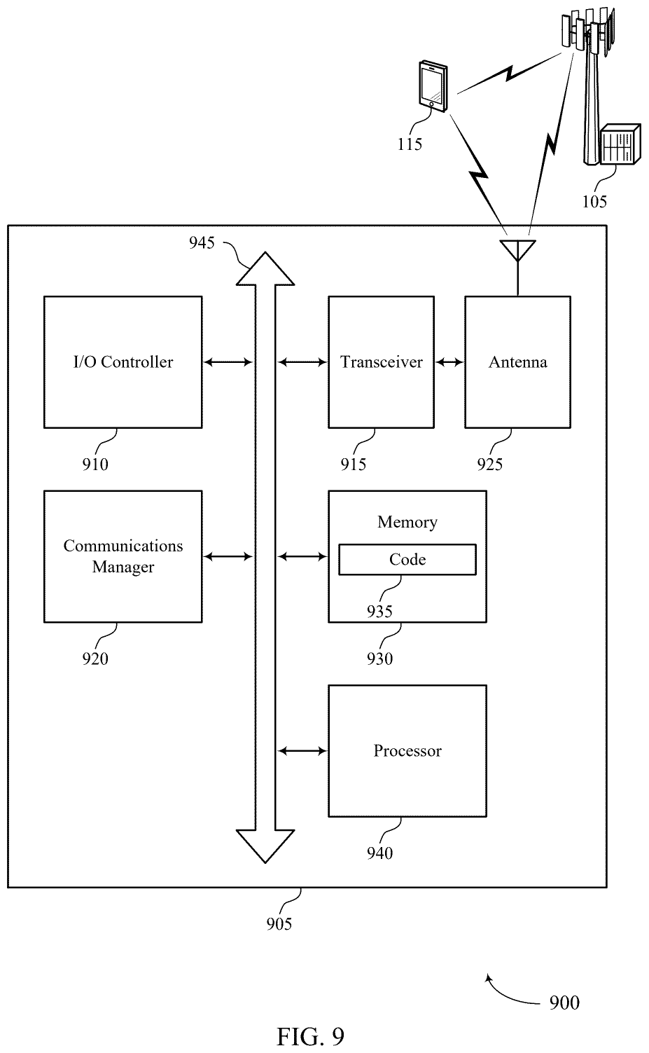

FIG. 9 shows a diagram of a system 900 including a device 905 that supports PRACH occasions for PRACH adaptation in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting PRACH occasions for PRACH adaptation). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period. The communications manager 920 is capable of, configured to, or operable to support a means for selectively performing one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions.

Additionally, or alternatively, the communications manager 920 may support wireless communications in accordance with examples as disclosed herein. For example, the communications manager 920 is capable of, configured to, or operable to support a means for receiving a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period. The communications manager 920 is capable of, configured to, or operable to support a means for selectively performing one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions.

Additionally, or alternatively, the communications manager 920 may support wireless communications in accordance with examples as disclosed herein. For example, the communications manager 920 is capable of, configured to, or operable to support a means for receiving a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold. The communications manager 920 is capable of, configured to, or operable to support a means for selectively performing one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

By including or configuring the communications manager 920 in accordance with examples as described herein, the device 905 may support techniques for improved PRACH configuration(s) to UE. The PRACH configuration(s) may generally define or otherwise identify whether additional PRACH occasions are available for use, are mapped to SSB indices, or otherwise considered as within a time period for such UE.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of PRACH occasions for PRACH adaptation as described herein, or the at least one processor 940 and the at least one memory 930 may be otherwise configured to, individually or collectively, perform or support such operations.

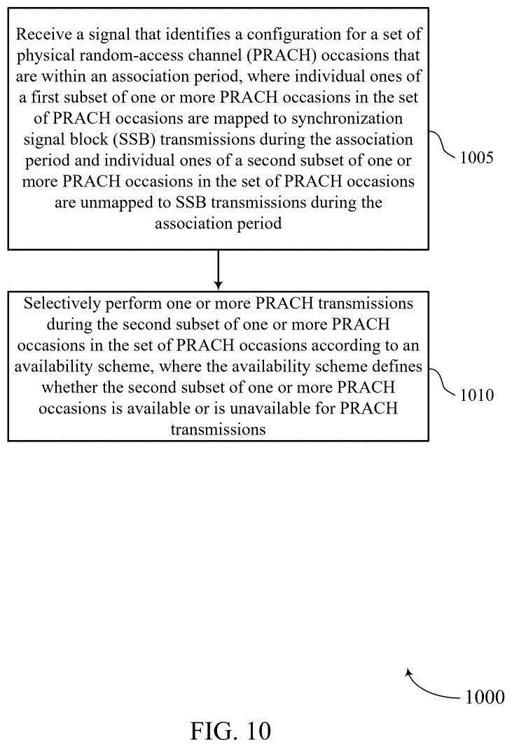

FIG. 10 shows a flowchart illustrating a method 1000 that supports PRACH occasions for PRACH adaptation in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a signal that identifies a configuration for a set of PRACH occasions that are within an association period, where individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period. The operations of 1005 may be performed in accordance with examples as disclosed herein. In some examples, aspects of the operations of 1005 may be performed by a configuration manager 825 as described with reference to FIG. 8.

At 1010, the method may include selectively performing one or more PRACH transmissions during the second subset of one or more PRACH occasions in the set of PRACH occasions according to an availability scheme, where the availability scheme defines whether the second subset of one or more PRACH occasions is available or is unavailable for PRACH transmissions. The operations of 1010 may be performed in accordance with examples as disclosed herein. In some examples, aspects of the operations of 1010 may be performed by a PRACH transmission manager 830 as described with reference to FIG. 8.

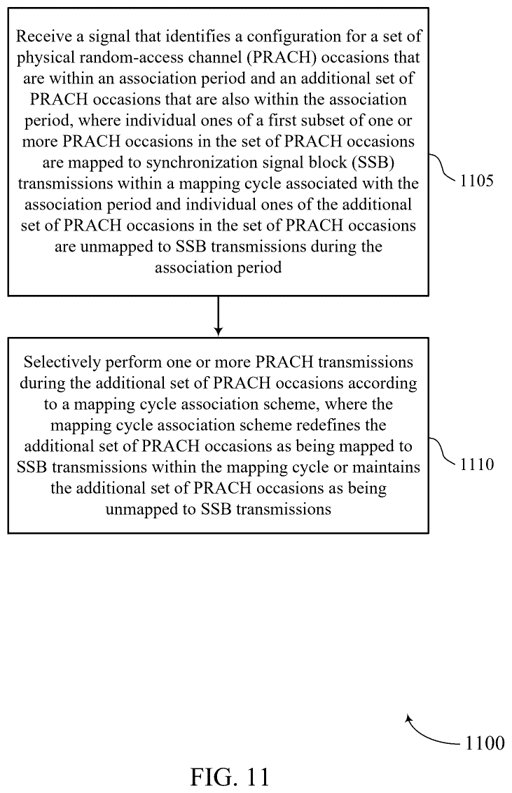

FIG. 11 shows a flowchart illustrating a method 1100 that supports PRACH occasions for PRACH adaptation in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a signal that identifies a configuration for a set of PRACH occasions that are within an association period and an additional set of PRACH occasions that are also within the association period, where individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period. The operations of 1105 may be performed in accordance with examples as disclosed herein. In some examples, aspects of the operations of 1105 may be performed by a configuration manager 825 as described with reference to FIG. 8.

At 1110, the method may include selectively performing one or more PRACH transmissions during the additional set of PRACH occasions according to a mapping cycle association scheme, where the mapping cycle association scheme redefines the additional set of PRACH occasions as being mapped to SSB transmissions within the mapping cycle or maintains the additional set of PRACH occasions as being unmapped to SSB transmissions. The operations of 1110 may be performed in accordance with examples as disclosed herein. In some examples, aspects of the operations of 1110 may be performed by a PRACH transmission manager 830 as described with reference to FIG. 8.

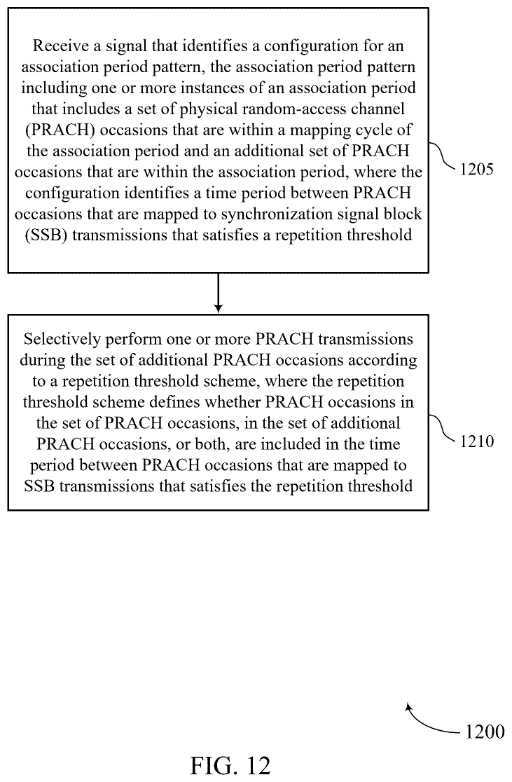

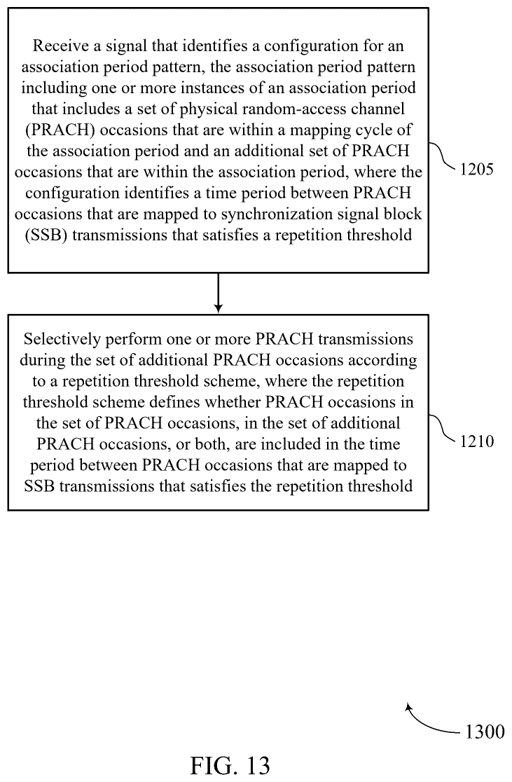

FIG. 12 shows a flowchart illustrating a method 1200 that supports PRACH occasions for PRACH adaptation in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving a signal that identifies a configuration for an association period pattern, the association period pattern including one or more instances of an association period that includes a set of PRACH occasions that are within a mapping cycle of the association period and an additional set of PRACH occasions that are within the association period, where the configuration identifies a time period between PRACH occasions that are mapped to SSB transmissions that satisfies a repetition threshold. The operations of 1205 may be performed in accordance with examples as disclosed herein. In some examples, aspects of the operations of 1205 may be performed by a configuration manager 825 as described with reference to FIG. 8.

At 1210, the method may include selectively performing one or more PRACH transmissions during the set of additional PRACH occasions according to a repetition threshold scheme, where the repetition threshold scheme defines whether PRACH occasions in the set of PRACH occasions, in the set of additional PRACH occasions, or both, are included in the time period between PRACH occasions that are mapped to SSB transmissions that satisfies the repetition threshold. The operations of 1210 may be performed in accordance with examples as disclosed herein. In some examples, aspects of the operations of 1210 may be performed by a PRACH transmission manager 830 as described with reference to FIG. 8.

The following provides an overview of aspects of the present disclosure:
Aspect 1: A method for wireless communications at a UE, comprising: receiving a signal that identifies a configuration for a set of PRACH occasions that are within an association period, wherein individual ones of a first subset of one or more PRACH occasions in the set of PRACH occasions are mapped to SSB transmissions during the association period and individual ones of a second subset of one or more PRACH occasions in the set of PRACH occasions are unmapped to SSB transmissions during the association period; and selectively performing one or more PRACH transmissions during the second subset of one or more PRACH occasions in the set of PRACH occasions according to an availability scheme, wherein the availability scheme defines whether the second subset of one or more PRACH occasions is available or is unavailable for PRACH transmissions.
Aspect 2: The method of aspect 1, wherein the availability scheme defines the second subset of one or more PRACH occasions as additional PRACH occasions that are available for PRACH transmissions.
Aspect 3: The method of any of aspects 1 through 2, wherein the availability scheme defines the second subset of one or more PRACH occasions as unavailable for PRACH transmissions.
Aspect 4: The method of any of aspects 1 through 3, further comprising: receiving a message that indicates the availability scheme to be applied to define the second subset of one or more PRACH occasions as available or as unavailable for PRACH transmissions.
Aspect 5: The method of any of aspects 1 through 4, further comprising: detecting an absence of a message that indicates the availability scheme to be applied to define the second subset of one or more PRACH occasions as available or as unavailable for PRACH transmissions; and selecting a default availability scheme as the availability scheme in accordance with the absence.
Aspect 6: The method of any of aspects 1 through 5, wherein the availability scheme is in accordance with whether the second subset of one or more PRACH occasions are within an association period associated with the set of PRACH occasions and outside of a mapping cycle associated with the set of PRACH occasions.
Aspect 7: A method for wireless communications at a UE, comprising: receiving a signal that identifies a configuration for a set of PRACH occasions that are within an association period and an additional set of PRACH occasions that are also within the association period, wherein individual ones of a first subset of one or more PRACH occasions in the set of PRACH occasions are mapped to SSB transmissions within a mapping cycle associated with the association period and individual ones of the additional set of PRACH occasions in the set of PRACH occasions are unmapped to SSB transmissions during the association period; and selectively performing one or more PRACH transmissions during the additional set of PRACH occasions according to a mapping cycle association scheme, wherein the mapping cycle association scheme redefines the additional set of PRACH occasions as being mapped to SSB transmissions within the mapping cycle or maintains the additional set of PRACH occasions as being unmapped to SSB transmissions.
Aspect 8: The method of aspect 7, wherein the mapping cycle association scheme redefines the additional set of PRACH occasions as being mapped to SSB transmissions within the mapping cycle.
Aspect 9: The method of any of aspects 7 through 8, wherein the mapping cycle association scheme maintains the additional set of PRACH occasions as being unmapped to SSB transmissions.
Aspect 10: A method for wireless communications at a UE, comprising: receiving a signal that identifies a configuration for an association period pattern, the association period pattern comprising one or more instances of an association period that comprises a set of PRACH occasions that are within a mapping cycle of the association period and an additional set of PRACH occasions that are within the association period, wherein the configuration identifies a time period between PRACH occasions that are mapped to SSB transmissions that satisfies a repetition threshold; and selectively performing one or more PRACH transmissions during the set of additional PRACH occasions according to a repetition threshold scheme, wherein the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.
Aspect 11: The method of aspect 10, wherein the repetition threshold scheme defines the PRACH occasions in the set of PRACH occasions as being included in the time period between PRACH occasions that are mapped to SSB transmissions that satisfies the repetition threshold.
Aspect 12: The method of any of aspects 10 through 11, wherein the repetition threshold scheme defines the PRACH occasions in both the set of PRACH occasions and the set of additional PRACH occasions as being included in the time period between PRACH occasions that are mapped to SSB transmissions that satisfies the repetition threshold.
Aspect 13: The method of any of aspects 10 through 12, wherein the repetition threshold scheme defines the PRACH occasions in the set of additional PRACH occasions as being included in the time period between PRACH occasions that are mapped to SSB transmissions that satisfies the repetition threshold.
Aspect 14: A UE for wireless communications, comprising one or more memories storing processor-executable code, and one or more processors coupled with the one or more memories and individually or collectively operable to execute the code to cause the UE to perform a method of any of aspects 1 through 6.
Aspect 15: A UE for wireless communications, comprising at least one means for performing a method of any of aspects 1 through 6.
Aspect 16: A non-transitory computer-readable medium storing code for wireless communications, the code comprising instructions executable by one or more processors to perform a method of any of aspects 1 through 6.
Aspect 17: A UE for wireless communications, comprising one or more memories storing processor-executable code, and one or more processors coupled with the one or more memories and individually or collectively operable to execute the code to cause the UE to perform a method of any of aspects 7 through 9.
Aspect 18: A UE for wireless communications, comprising at least one means for performing a method of any of aspects 7 through 9.
Aspect 19: A non-transitory computer-readable medium storing code for wireless communications, the code comprising instructions executable by one or more processors to perform a method of any of aspects 7 through 9.
Aspect 20: A UE for wireless communications, comprising one or more memories storing processor-executable code, and one or more processors coupled with the one or more memories and individually or collectively operable to execute the code to cause the UE to perform a method of any of aspects 10 through 13.
Aspect 21: A UE for wireless communications, comprising at least one means for performing a method of any of aspects 10 through 13.
Aspect 22: A non-transitory computer-readable medium storing code for wireless communications, the code comprising instructions executable by one or more processors to perform a method of any of aspects 10 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a signal that identifies a configuration for a set of physical random-access channel (PRACH) occasions that are within an association period, wherein individual ones of a first subset of one or more PRACH occasions in the set of PRACH occasions are mapped to synchronization signal block (SSB) transmissions during the association period and individual ones of a second subset of one or more PRACH occasions in the set of PRACH occasions are unmapped to SSB transmissions during the association period; and
selectively perform one or more PRACH transmissions during the second subset of one or more PRACH occasions in the set of PRACH occasions according to an availability scheme, wherein the availability scheme defines whether the second subset of one or more PRACH occasions is available or is unavailable for PRACH transmissions.

2. The UE of claim 1, wherein the availability scheme defines the second subset of one or more PRACH occasions as additional PRACH occasions that are available for PRACH transmissions.

3. The UE of claim 1, wherein the availability scheme defines the second subset of one or more PRACH occasions as unavailable for PRACH transmissions.

4. The UE of claim 1, wherein the one or more processors are individually or collectively further operable to execute the code to cause the UE to:
receive a message that indicates the availability scheme to be applied to define the second subset of one or more PRACH occasions as available or as unavailable for PRACH transmissions.

5. The UE of claim 1, wherein the one or more processors are individually or collectively further operable to execute the code to cause the UE to:
detect an absence of a message that indicates the availability scheme to be applied to define the second subset of one or more PRACH occasions as available or as unavailable for PRACH transmissions; and
select a default availability scheme as the availability scheme in accordance with the absence.

6. The UE of claim 1, wherein the availability scheme is in accordance with whether the second subset of one or more PRACH occasions are within an association period associated with the set of PRACH occasions and outside of a mapping cycle associated with the set of PRACH occasions.

7. A user equipment (UE), comprising:
one or more memories storing processor-executable code; and
one or more processors coupled with the one or more memories and individually or collectively operable to execute the code to cause the UE to:
receive a signal that identifies a configuration for a set of physical random-access channel (PRACH) occasions that are within an association period and an additional set of PRACH occasions that are also within the association period, wherein individual ones of a first subset of one or more PRACH occasions in the set of PRACH occasions are mapped to synchronization signal block (SSB) transmissions within a mapping cycle associated with the association period and individual ones of the additional set of PRACH occasions in the set of PRACH occasions are unmapped to SSB transmissions during the association period; and
selectively perform one or more PRACH transmissions during the additional set of PRACH occasions according to a mapping cycle association scheme, wherein the mapping cycle association scheme redefines the additional set of PRACH occasions as being mapped to SSB transmissions within the mapping cycle or maintains the additional set of PRACH occasions as being unmapped to SSB transmissions.

8. The UE of claim 7, wherein the mapping cycle association scheme redefines the additional set of PRACH occasions as being mapped to SSB transmissions within the mapping cycle.

9. The UE of claim 7, wherein the mapping cycle association scheme maintains the additional set of PRACH occasions as being unmapped to SSB transmissions.

10. A user equipment (UE), comprising:
one or more memories storing processor-executable code; and
one or more processors coupled with the one or more memories and individually or collectively operable to execute the code to cause the UE to:
receive a signal that identifies a configuration for an association period pattern, the association period pattern comprising one or more instances of an association period that comprises a set of physical random-access channel (PRACH) occasions that are within a mapping cycle of the association period and an additional set of PRACH occasions that are within the association period, wherein the configuration identifies a time period between PRACH occasions that are mapped to synchronization signal block (SSB) transmissions that satisfies a repetition threshold; and
selectively perform one or more PRACH transmissions during the set of additional PRACH occasions according to a repetition threshold scheme, wherein the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

11. The UE of claim 10, wherein the repetition threshold scheme defines the PRACH occasions in the set of PRACH occasions as being included in the time period between PRACH occasions that are mapped to SSB transmissions that satisfies the repetition threshold.

12. The UE of claim 10, wherein the repetition threshold scheme defines the PRACH occasions in both the set of PRACH occasions and the set of additional PRACH occasions as being included in the time period between PRACH occasions that are mapped to SSB transmissions that satisfies the repetition threshold.

13. The UE of claim 10, wherein the repetition threshold scheme defines the PRACH occasions in the set of additional PRACH occasions as being included in the time period between PRACH occasions that are mapped to SSB transmissions that satisfies the repetition threshold.

14. A method for wireless communications at a user equipment (UE), comprising:
receiving a signal that identifies a configuration for a set of physical random-access channel (PRACH) occasions that are within an association period, wherein individual ones of a first subset of one or more PRACH occasions in the set of PRACH occasions are mapped to synchronization signal block (SSB) transmissions during the association period and individual ones of a second subset of one or more PRACH occasions in the set of PRACH occasions are unmapped to SSB transmissions during the association period; and
selectively performing one or more PRACH transmissions during the second subset of one or more PRACH occasions in the set of PRACH occasions according to an availability scheme, wherein the availability scheme defines whether the second subset of one or more PRACH occasions is available or is unavailable for PRACH transmissions.

15. The method of claim 14, wherein the availability scheme defines the second subset of one or more PRACH occasions as additional PRACH occasions that are available for PRACH transmissions.

16. The method of claim 14, wherein the availability scheme defines the second subset of one or more PRACH occasions as unavailable for PRACH transmissions.

17. The method of claim 14, further comprising:
receiving a message that indicates the availability scheme to be applied to define the second subset of one or more PRACH occasions as available or as unavailable for PRACH transmissions.

18. The method of claim 14, further comprising:
detecting an absence of a message that indicates the availability scheme to be applied to define the second subset of one or more PRACH occasions as available or as unavailable for PRACH transmissions; and
selecting a default availability scheme as the availability scheme in accordance with the absence.

19. The method of claim 14, wherein the availability scheme is in accordance with whether the second subset of one or more PRACH occasions are within an association period associated with the set of PRACH occasions and outside of a mapping cycle associated with the set of PRACH occasions.

20. A method for wireless communications at a user equipment (UE), comprising:
receiving a signal that identifies a configuration for a set of physical random-access channel (PRACH) occasions that are within an association period and an additional set of PRACH occasions that are also within the association period, wherein individual ones of a first subset of one or more PRACH occasions in the set of PRACH occasions are mapped to synchronization signal block (SSB) transmissions within a mapping cycle associated with the association period and individual ones of the additional set of PRACH occasions in the set of PRACH occasions are unmapped to SSB transmissions during the association period; and
selectively performing one or more PRACH transmissions during the additional set of PRACH occasions according to a mapping cycle association scheme, wherein the mapping cycle association scheme redefines the additional set of PRACH occasions as being mapped to SSB transmissions within the mapping cycle or maintains the additional set of PRACH occasions as being unmapped to SSB transmissions.

21. The method of claim 20, wherein the mapping cycle association scheme redefines the additional set of PRACH occasions as being mapped to SSB transmissions within the mapping cycle.

22. The method of claim 20, wherein the mapping cycle association scheme maintains the additional set of PRACH occasions as being unmapped to SSB transmissions.

23. A method for wireless communications at a user equipment (UE), comprising:
receiving a signal that identifies a configuration for an association period pattern, the association period pattern comprising one or more instances of an association period that comprises a set of physical random-access channel (PRACH) occasions that are within a mapping cycle of the association period and an additional set of PRACH occasions that are within the association period, wherein the configuration identifies a time period between PRACH occasions that are mapped to synchronization signal block (SSB) transmissions that satisfies a repetition threshold; and
selectively performing one or more PRACH transmissions during the set of additional PRACH occasions according to a repetition threshold scheme, wherein the repetition threshold scheme defines whether PRACH occasions in the set of PRACH occasions, in the set of additional PRACH occasions, or both, are included in the time period between PRACH occasions that are mapped to SSB transmissions that satisfies the repetition threshold.

24. The method of claim 23, wherein the repetition threshold scheme defines the PRACH occasions in the set of PRACH occasions as being included in the time period between PRACH occasions that are mapped to SSB transmissions that satisfies the repetition threshold.

25. The method of claim 23, wherein the repetition threshold scheme defines the PRACH occasions in both the set of PRACH occasions and the set of additional PRACH occasions as being included in the time period between PRACH occasions that are mapped to SSB transmissions that satisfies the repetition threshold.

26. The method of claim 23, wherein the repetition threshold scheme defines the PRACH occasions in the set of additional PRACH occasions as being included in the time period between PRACH occasions that are mapped to SSB transmissions that satisfies the repetition threshold.
